(19) United States
(12) Patent Application Publication
(10) Pub. No.: US 2011/0298499 A1
(43) Pub. Date: Dec. 8, 2011

(54) INTERNAL VOLTAGE GENERATOR AND INTEGRATED CIRCUIT DEVICE INCLUDING THE SAME

(75) Inventors: Ho-Seok Seol, Daegu (KR); Seung-Jun Bae, Hwaseong-si (KR)

(73) Assignee: SAMSUNG ELECTRONICS CO., LTD., Suwon-si (KR)

(21) Appl. No.: 13/110,242

(22) Filed: May 18, 2011

Related U.S. Application Data
(60) Provisional application No. 61/351,356, filed on Jun. 4, 2010.

(30) Foreign Application Priority Data
Oct. 8, 2010 (KR) 10-2010-0098018

(51) Int. Cl. G05F 3/16

(52) U.S. Cl. 327/77

(57) ABSTRACT

An internal voltage generator includes a comparison unit, a driving circuit and a bias unit. The comparison unit compares a reference voltage and an internal voltage and is configured to output a comparison voltage, which is based on a difference between the reference voltage and the internal voltage. The driving circuit receives the comparison voltage and an external power supply voltage and is configured to output the internal voltage to an output node in response to the comparison voltage. The bias unit receives the internal voltage and is configured to adaptively adjust a bias current that flows through the bias unit to drive the comparison unit, in consideration of a level of the internal voltage.

### CROSS-REFERENCE TO RELATED APPLICATION(S)

This US non-provisional application claims the benefit of priority under 35 USC §119 to U.S. Provisional Application No. 61/351,356 filed on Jun. 4, 2010 in the United States Patent and Trademark Office (USPTO) and Korean Patent Application No. 10-2010-0098018 filed on Oct. 8, 2010 in the Korean Intellectual Property Office (KIPO), the contents of which applications are herein incorporated by reference in their entirety.

### BACKGROUND

1. Technical Field

Exemplary embodiments relate to semiconductor devices, and more particularly, to an internal voltage generator and an integrated circuit device having the internal voltage generator.

2. Description of the Related Art

The internal voltages at which semiconductor memory devices operate have decreased in recent years. A typical semiconductor memory device converts an external power supply voltage to an internal voltage having a relatively low level. Reliable operation of a semiconductor memory device may be achieved when the internal voltage is stabilized after a predetermined time after the external power supply voltage VDD is applied has elapsed. A stable internal power supply voltage is desirable because the internal voltage is used as the power supply voltage of internal circuits such as peripheral logic circuits and a memory core. These circuits require a stable power supply voltage to achieve reliable device operation.

### SUMMARY

Accordingly, the inventive concept is provided to substantially obviate one or more drawbacks due to limitations and disadvantages of the related art.

Some exemplary embodiments provide an internal voltage generator with reduced power consumption and a stable internal voltage.

Some exemplary embodiments provide an integrated circuit device which includes the internal voltage generator.

According to one aspect, the inventive concept is directed to an internal voltage generator for a semiconductor memory device, which includes a comparison unit, a driving circuit and a bias unit. The comparison unit compares a reference voltage and an internal voltage and is configured to output a comparison voltage based on a difference between the reference voltage and the internal voltage. The driving circuit receives the comparison voltage and an external power supply voltage and is configured to output the internal voltage to an output node in response to the comparison voltage. The bias unit receives the internal voltage and is configured to adaptively adjust a bias current flowing through the bias unit to drive the comparison unit, in consideration of a level of the internal voltage.

In some exemplary embodiments, the comparison unit may include a first p-type metal-oxide semiconductor (PMOS) transistor which is connected between the external power supply voltage and a first node, a second PMOS transistor which is connected between the external power supply voltage and a second node, a first n-type MOS (NMOS) transistor which is connected between the first node and a third node connected to the driving circuit and a second NMOS transistor which is connected between the second node and the third node. The comparison voltage may be provided at the first node, the first and second PMOS transistor may form a current mirror circuit, the gate of the first NMOS transistor may receive the reference voltage, and the gate of the second NMOS transistor may receive the internal voltage.

In some exemplary embodiments, the driving circuit may include a third PMOS transistor, the source of which is connected to the external power supply voltage, the drain of which is connected to the output node, and the gate of which receives the comparison voltage.

In some exemplary embodiments, the bias unit may include a comparator which compares voltage levels of the first and second nodes to provide a bias voltage according to the result of the comparison and a third NMOS transistor, connected to the third node and a ground voltage, the gate of which receives the bias voltage to adjust the bias current in response to the bias voltage.

In some exemplary embodiments, the bias unit may increase the bias current when the voltage level of the second node decreases.

In some exemplary embodiments, the bias unit may decrease the bias current when the voltage level of the second node increases.

In some exemplary embodiments, the bias unit may include a comparator which compares levels of the reference voltage and the internal voltage to provide a bias voltage according to the result of the comparison and a third NMOS transistor, connected to the third node and a ground voltage, the gate of which receives the bias voltage to adjust the bias current in response to the bias voltage.

In some exemplary embodiments, the bias unit may increase the bias current when the level of the internal voltage decreases.

In some exemplary embodiments, the bias unit may decrease the bias current when the level of the internal voltage increases.

According to another aspect, the inventive concept is directed to an internal voltage generator for a semiconductor memory device, which includes a comparison unit, a driving circuit, a selection unit and a bias unit. The comparison unit compares one of a plurality of internal voltages and a reference voltage and is configured to output a comparison voltage based on a difference between the one of the plurality of internal voltages and the reference voltage. The driving circuit receives an external power supply voltage and the comparison voltage and is configured to selectively generate one of the internal voltages to be provided to an internal circuit in response to a control signal. The selection unit receives the internal voltages and is configured to select one of the internal voltages in response to the control signal, and the selected one of the internal voltages is provided to the internal circuit as a selected internal voltage. The bias unit receives the selected internal voltage and is configured to adaptively adjust a bias current to drive the comparison unit, in consideration of a level of the selected internal voltage.

In some exemplary embodiments, the driving circuit may include first and second driving units which are selectively enabled in response to the control signal and which output one of the internal voltages based on the external power supply voltage and the comparison voltage.

In some exemplary embodiments, the first driving unit may include a first p-type metal-oxide semiconductor (PMOS) transistor, connected to the external power supply voltage, the gate of which receives the control signal, and a second PMOS transistor, connected to the first PMOS transistor and the selection unit, the gate of which receives the comparison voltage. The second driving unit may include a third NMOS transistor, connected to the external power supply voltage, the gate of which receives an inverted version of the control signal, and a fourth PMOS transistor, connected to the third PMOS transistor and the selection unit, the gate of which receives the comparison voltage. A first internal voltage may be provided at a drain of the second PMOS transistor, and a second internal voltage may be provided at a drain of the fourth PMOS transistor.

In some exemplary embodiments, the first internal voltage may be selectively provided based on whether the first PMOS transistor is turned on in response to the control signal, and the second internal voltage may be selectively provided based on whether the third PMOS transistor is turned on in response to the inverted version of the control signal.

In some exemplary embodiments, the comparison unit may include a fifth PMOS transistor which is connected between the external power supply voltage and a first node with the comparison voltage being provided at the first node, a sixth PMOS transistor which is connected between the external power supply voltage and a second node, a first n-type MOS (NMOS) transistor, connected between the first node and a third node connected to the driving circuit, the gate of which receives the reference voltage, and a second NMOS transistor, connected between the second node and the third node, the gate of which receives the internal voltage. The first and second PMOS transistor may form a current mirror circuit.

In some exemplary embodiments, the bias unit may include a comparator which compares levels of the reference voltage and the selected internal voltage to provide a comparison result, a bias voltage being provided according to the comparison result, and a third NMOS transistor, connected to the third node and a ground voltage, the gate of which receives the bias voltage to adjust the bias current in response to the bias voltage.

In some exemplary embodiments, the selection unit may include a multiplexer which selects one of the first and second internal voltages to output the selected internal voltage.

In some exemplary embodiments, the selection unit may select the first internal voltage of the first and second internal voltages when the control signal is a first logic level, and the selection unit may select the second internal voltage of the first and second internal voltages when the control signal is a second logic level.

According to another aspect, the inventive concept is directed to an integrated circuit device comprising an internal voltage generator circuit and an internal circuit. The internal voltage generator circuit comprises: a comparison unit for comparing a reference voltage and the internal voltage, the comparison unit being configured to output a comparison voltage based on a difference between the reference voltage and the internal voltage, a driving circuit which receives the comparison voltage and an external power supply voltage, the driving circuit being configured to output the internal voltage to an output node in response to the comparison voltage, and a bias unit which receives the internal voltage and through which a bias current flows, the bias unit being configured to adaptively adjust the bias current to drive the comparison unit, in consideration of a level of the internal voltage. The internal circuit receives the internal voltage and uses the internal voltage as an operating voltage.

In some exemplary embodiments, the integrated circuit device comprises a semiconductor memory device. In some exemplary embodiments, the semiconductor memory device comprises a DRAM device.

In some exemplary embodiments, the internal circuit comprises a memory cell array. In some exemplary embodiments, the memory cell array is a DRAM memory cell array.

In some exemplary embodiments, the internal circuit comprises a peripheral circuit associated with a memory cell array. In some exemplary embodiments, the internal circuit comprises a memory circuit and a peripheral circuit associated with the memory cell array.

According to exemplary embodiments of the inventive concept, power consumption may be reduced while a stable internal voltage is generated by adaptively adjusting the bias current according to the amount of the load current applied to the internal circuit.

### BRIEF DESCRIPTION OF THE DRAWINGS

The foregoing and other features and advantages of the inventive concept will be apparent from the detailed description of preferred embodiments of the inventive concept contained herein, as illustrated in the accompanying drawings, in which like reference characters refer to the same parts or elements throughout the different views. The drawings are not necessarily to scale, emphasis instead being placed upon illustrating the principles of the inventive concept.

FIG. 1 is a schematic block diagram illustrating an internal voltage generator, according to some exemplary embodiments of the inventive concept.

FIG. 2 is a schematic circuit diagram illustrating an example of the internal voltage generator of FIG. 1, according to some exemplary embodiments of the inventive concept.

FIG. 3 is a schematic circuit diagram illustrating an example of the bias unit in FIG. 1, according to some exemplary embodiments of the inventive concept.

FIG. 4 is a schematic circuit diagram illustrating an example of the bias unit in FIG. 1, according to some exemplary embodiments of the inventive concept.

FIG. 5 is schematic block diagram illustrating an internal voltage generator, according to some exemplary embodiments of the inventive concept.

FIG. 6A is a schematic circuit diagram illustrating an example of the internal voltage generator of FIG. 5, according to some exemplary embodiments of the inventive concept.

FIG. 6B is a schematic circuit diagram illustrating an example of the internal voltage generator of FIG. 5, according to some exemplary embodiments of the inventive concept.

FIG. 7 is a schematic block diagram illustrating an example of an integrated circuit device, according to some exemplary embodiments of the inventive concept.

FIG. 8 is a schematic block diagram illustrating an example of an integrated circuit device, according to some exemplary embodiments of the inventive concept.

FIG. 9 is a schematic block diagram illustrating a system which includes semiconductor memory devices, according to some exemplary embodiments of the inventive concept.

### DETAILED DESCRIPTION OF THE EMBODIMENTS

Various exemplary embodiments will be described in detail hereinafter with reference to the accompanying drawings, in which some exemplary embodiments are shown. The present inventive concept may, however, be embodied in many different forms and should not be construed as limited to the exemplary embodiments set forth herein. Rather, these exemplary embodiments are provided so that this description will be thorough and complete, and will fully convey the present inventive concept to those skilled in the art. In the drawings, the sizes and relative sizes of layers and regions may be exaggerated for clarity.

It will be understood that, although the terms first, second, third, etc., may be used herein to describe various elements, these elements should not be limited by these terms. These terms are used to distinguish one element from another. Thus, a first element described below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion, e.g., “between” versus “directly between,” “adjacent” versus “directly adjacent,” etc.).

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

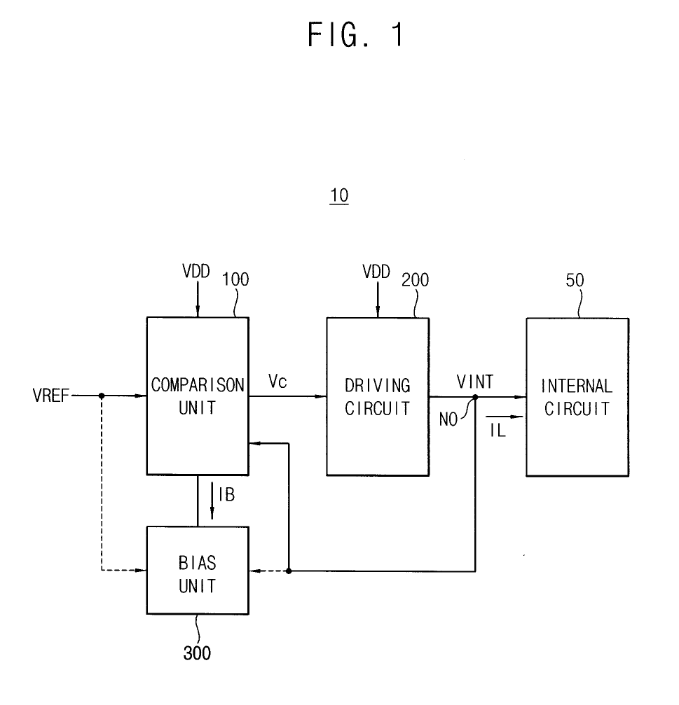

FIG. 1 is a schematic block diagram illustrating an internal voltage generator for a semiconductor memory device according to some exemplary embodiments. Referring to FIG. 1, in some exemplary embodiments, the internal voltage generator 10 includes a comparison unit 100, a driving circuit 200 and a bias unit 300. The internal voltage VINT generated by the internal voltage generator 10 is applied to a general internal circuit 50. The internal circuit 50 uses the internal voltage VINT as an operating voltage. It is noted that the internal circuit 50 is generally any internal circuit which receives the internal voltage VINT and uses the internal voltage VINT as its operating voltage.

The comparison unit 100 compares a reference voltage VREF and the internal voltage VINT, generated at an output node NO. In response to the comparison, the comparison unit outputs a comparison voltage Vc based on a difference between the reference voltage VREF and the internal voltage VINT. The driving circuit 200 receives the comparison voltage Vc and an external power supply voltage VDD and outputs the internal voltage VINT to the output node NO in response to the comparison voltage Vc. A load current IL, generated in response to the internal voltage VINT, is provided from the output node NO to the internal circuit 50. A bias current IB for driving the comparison unit 100, specifically, for biasing transistors included in the comparison unit 100, is adaptively adjusted by the bias unit 300, in consideration of a level of the internal voltage VINT. That is, the internal voltage generator 10 may adaptively adjust the bias current IB for driving the comparison unit 100, i.e., for biasing transistors included in the comparison unit 100, according to the level of the internal voltage VINT.

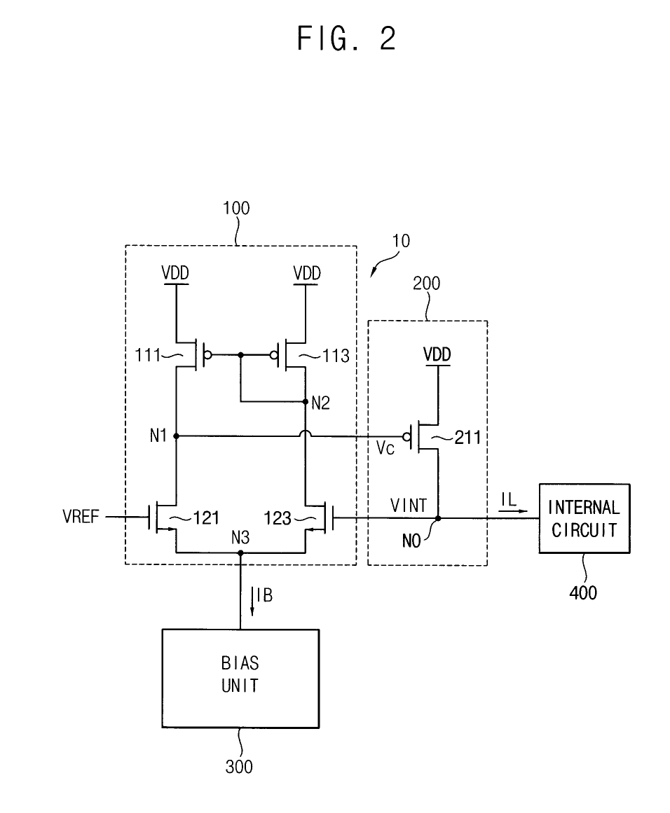

FIG. 2 is a schematic circuit diagram illustrating an example of the internal voltage generator 10 of FIG. 1, according to some exemplary embodiments. Referring to FIG. 2, in some exemplary embodiments, the comparison unit 100 includes a first p-type metal oxide semiconductor (PMOS) transistor 111, a second PMOS transistor 113, a first n-type metal oxide semiconductor (NMOS) transistor 121 and a second NMOS transistor 123. The first PMOS transistor 111 is connected between the external power supply voltage VDD and a first node N1 at which the comparison voltage Vc is output. The second PMOS transistor 113 is connected between the external power supply voltage VDD and a second node N2. The first and second PMOS transistors 111 and 113 form a current mirror. The first NMOS transistor 121 is connected between the first node N1 and a third node N3 to which the bias unit 300 is connected. The gate of the first NMOS transistor receives the reference voltage VREF. The second NMOS transistor 123 is connected between the second node N2 and the third node N3. The gate of the second NMOS transistor 123 receives the internal voltage VINT.

The driving circuit 200 may include a third PMOS transistor 211. The source of the third PMOS transistor 211 is connected to the external power supply voltage VDD. The drain of the third PMOS transistor 211 is connected to the output node NO. The gate of the third PMOS transistor 211 receives the comparison voltage Vc.

As illustrated in FIG. 2, in some exemplary embodiments, the comparison unit 100 is configured as a type of differential amplifier. As such, voltage levels of the first and second node N1 and N2 have little difference with respect to each other. The voltage level of the first node N1 is variable according to the load current IL flowing into the internal circuit 400. That is, when the load current IL increases, the level of the internal voltage VINT decreases, and thus the voltage level of the first node N1 decreases. In addition, the voltage level of the second node N2 is variable according to the driving current IB flowing into the bias unit 300. When the driving current IB increases, the voltage level of the third node decreases, and thus, the voltage level of the second node N2 decreases. Hence, according to some exemplary embodiments of the inventive concept, a stable internal voltage VINT and reduced current consumption are realized by adaptively adjusting the driving current IB according to changes of the load current IL.

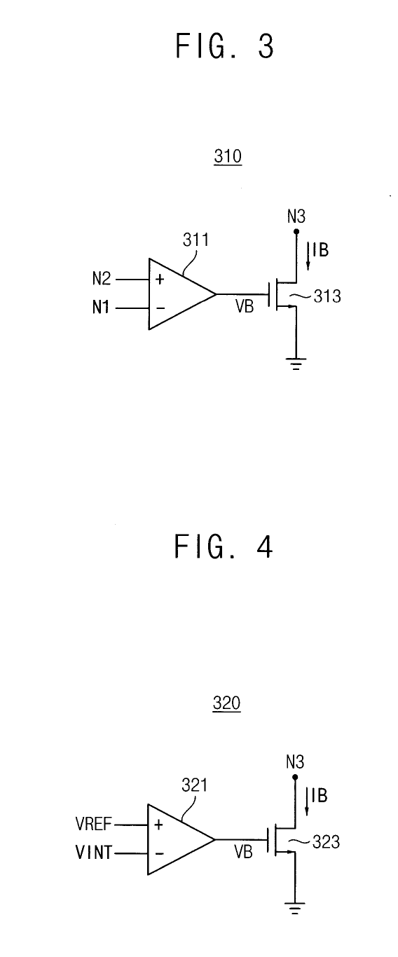

FIG. 3 is a schematic circuit diagram illustrating an example of the bias unit in FIG. 1 according to some exemplary embodiments. Referring to FIG. 3, the bias unit 310 according to these exemplary embodiments may include a comparator 311 and a third NMOS transistor 313. The comparator 311 includes a first (positive) input terminal which is connected to the second node N2 and a second (negative) input terminal which is connected to the first node N1. The comparator 311 compares the voltage levels of the first node N1 and the second node N2 to output a bias voltage VB according to the result of the comparison. The drain of the third NMOS transistor 313 is connected to the third node N3. The source of the third NMOS transistor 313 is connected to ground, and the gate of the third NMOS transistor 313 receives the bias voltage VB. For example, referring to FIGS. 2 and 3, when the load current IL increases, the level of the internal voltage VINT decreases. When the level of the internal voltage VINT decreases, the voltage level of the first node N1 is lower than the voltage level of the second node N2, because more current is flowing through the first NMOS transistor 121 than the second NMOS transistor 123. When the voltage level of the first node N1 is lower than the voltage level of the second node N2, the level of the bias voltage VB from the comparator 311 increases, and thus, the bias current IB, flowing from the third node N3 through the third NMOS transistor 313 to the ground, increases.

For example, with reference to FIGS. 2 and 3, when the load current IL decreases, the level of the internal voltage VINT increases. When the level of the internal voltage VINT increases, the voltage level of the first node N1 is higher than the voltage level of the second node N2, because less current is flowing through the first NMOS transistor 121 than the second NMOS transistor 123. When the voltage level of the first node N1 is higher than the voltage level of the second node N2, the level of the bias voltage VB from the comparator 311 decreases, and thus, the bias current IB, flowing from the third node N3 through the third NMOS transistor 313 to ground, decreases. Accordingly, in exemplary embodiments of the inventive concept, the level of the internal voltage VINT is varied according to an amount of the load current flowing through the internal circuit 50, and the bias current IB for driving the comparison unit 100 may be adaptively adjusted in consideration of the level of the internal voltage VINT.

FIG. 4 is a schematic circuit diagram illustrating another example of the bias unit in FIG. 1, according to some exemplary embodiments. Referring to FIG. 4, a bias unit 320 according to these exemplary embodiments may include a comparator 321 and a fourth NMOS transistor 323. The comparator 321 includes a first (positive) input terminal connected to the reference voltage VREF and a second (negative) input terminal connected to the internal voltage VINT. The comparator 321 compares the levels of the reference voltage VREF and the internal voltage VINT to output a bias voltage VB according to the result of the comparison. The drain of the fourth NMOS transistor 323 is connected to the third node N3. The source of the fourth NMOS transistor 323 is connected to ground, and the gate of the fourth NMOS transistor 323 receives the bias voltage VB. In some exemplary embodiments, the level of the reference voltage VREF may be substantially fixed. For example, with reference to FIGS. 2 and 4, when the load current IL increases, the level of the internal voltage VINT decreases. When the level of the internal voltage VINT decreases, the level of the bias voltage VB output from the comparator 321 increases. When the level of the bias voltage VB increases, the bias current IB, flowing from the third node N3 through the fourth NMOS transistor 323 to ground, increases.

For example, with reference to FIGS. 2 and 4, when the load current IL decreases, the level of the internal voltage VINT increases. When the level of the internal voltage VINT increases, the level of the bias voltage VB output from the comparator 321 decreases. When the level of the bias voltage VB decreases, the bias current IB, flowing from the third node N3 through the fourth NMOS transistor 323 to ground, decreases. Accordingly, in exemplary embodiments of the inventive concept, the level of the internal voltage VINT is varied according to an amount of the load current flowing through the internal circuit 50, and the bias current IB for driving the comparison unit 100 may be adaptively adjusted in consideration of the level of the internal voltage VINT.

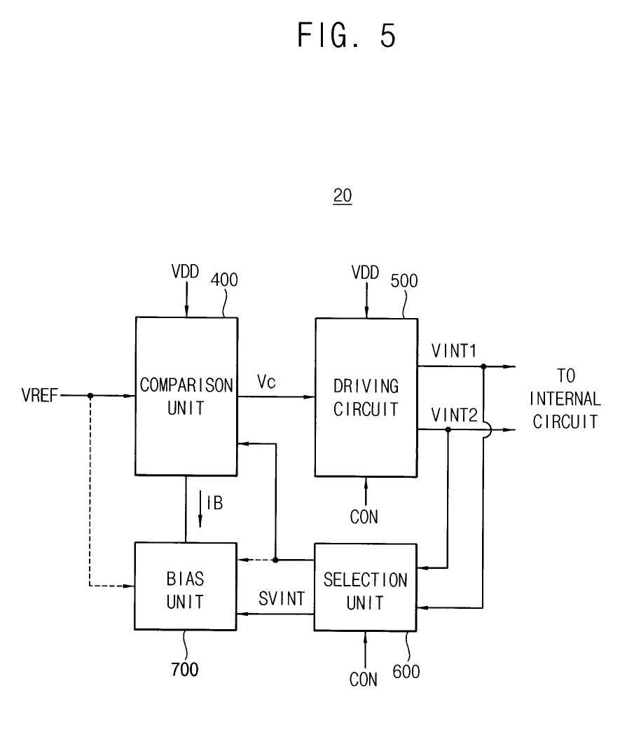

FIG. 5 is schematic block diagram illustrating another internal voltage generator for a semiconductor memory device according to some exemplary embodiments of the inventive concept. It is noted that detailed description of elements, features or aspects of the embodiments of FIG. 5 that are the same as those of the embodiments of FIG. 1 will not be repeated. Referring to FIG. 5, in some exemplary embodiments, the internal voltage generator 20 includes a comparison unit 400, a driving circuit 500, a selection unit 600 and a bias unit 700.

The comparison unit 400 compares one of a plurality of internal voltages, i.e., a selected internal voltage SVINT, and a reference voltage VREF and outputs a comparison voltage Vc based on a difference between the a selected internal voltage SVINT and the reference voltage VREF. The driving circuit 500 receives an external power supply voltage VDD and the comparison voltage Vc and selectively generates one of the internal voltages VINT1 and VINT2 to be provided to an internal circuit in response to a control signal CON. The selection unit 600 also selects one of the internal voltages VINT1 and VINT2 in response to the control signal CON, and provides the selected one of the internal voltages VINT1 or VINT2 to the comparison unit 400 as the selected internal voltage SVINT. The bias unit 700 adaptively adjusts a bias current IB that drives the comparison unit 400, specifically, biases transistors in the comparison unit 400, in consideration of a level of the selected internal voltage SVINT. In some exemplary embodiments the first and second internal voltages VINT1 and VINT2 may have the same voltage level, and may be provided to the internal circuit through separate power supply lines.

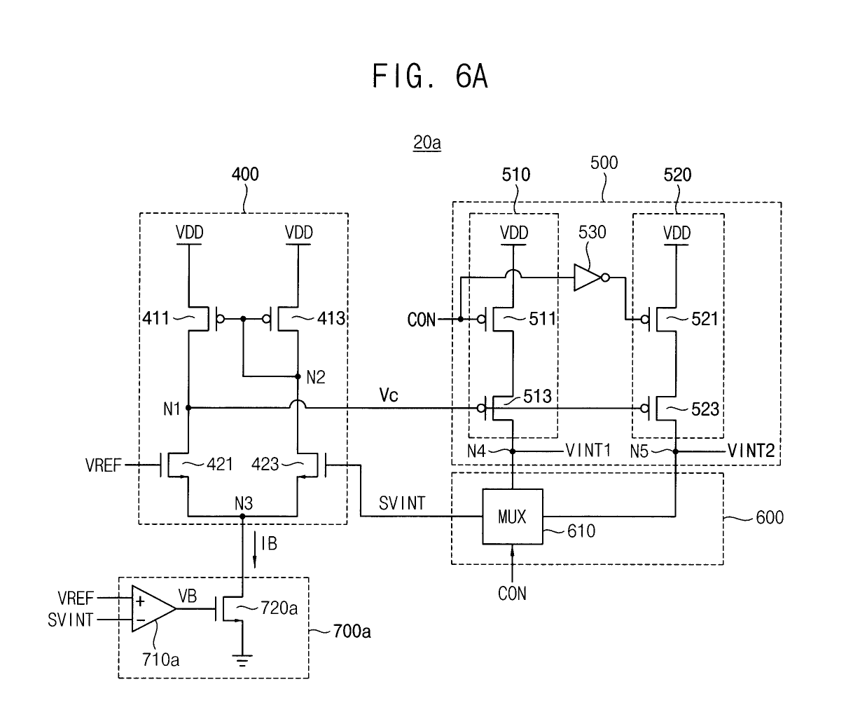

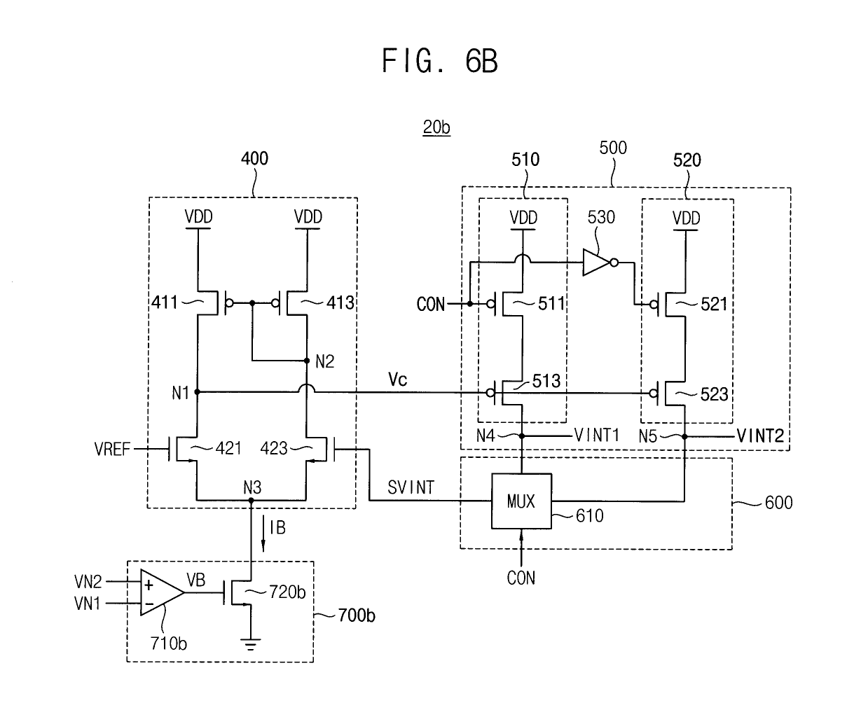

FIG. 6A is a schematic circuit diagram illustrating an example of the internal voltage generator of FIG. 5 according to some exemplary embodiments. Referring to FIG. 6A, the internal voltage generator 20a according to these embodiments may include the comparison unit 400, the driving circuit 500, the selection unit 600 and a bias unit 700a.

In some exemplary embodiments, the comparison unit 400 includes a first PMOS transistor 411, a second PMOS transistor 413, a first NMOS transistor 421 and a second NMOS transistor 423. The first PMOS transistor 411 is connected between the external power supply voltage VDD and a first node N1 at which the comparison voltage Vc is output. The second PMOS transistor 413 is connected between the external power supply voltage VDD and a second node N2. The first and second PMOS transistors 411 and 413 form a current mirror. The first NMOS transistor 421 is connected between the first node N1 and a third node N3 to which the bias unit 700a is connected. The gate of the first NMOS transistor 421 receives the reference voltage VREF. The second NMOS transistor 423 is connected between the second node N2 and the third node N3. The gate of the second NMOS transistor 423 receives the selected internal voltage SVINT.

In some exemplary embodiments, the driving unit 500 includes a first driving unit 510, a second driving unit 520 and an inverter 530 coupled between the first driving unit 510 and the second driving unit 520. The first driving unit 510 is connected to the selection unit 600 at a fourth node N4, and a first internal voltage VINT1 is provided at the fourth node N4. The second driving unit 520 is connected to the selection unit 600 at a fifth node N5, and a second internal voltage VINT2 is provided at the fifth node N5. The first driving unit 510 includes a third PMOS transistor 511 and a fourth PMOS transistor 513. The third PMOS transistor 511 is connected to the external power supply voltage VDD. The gate of the third PMOS transistor 511 receives the control signal CON. The fourth PMOS transistor 513 is connected between the third PMOS transistor 511 and the fourth node N4. The gate of the fourth PMOS transistor 513 receives the comparison voltage Vc. The second driving unit 520 includes a fifth PMOS transistor 521 and a sixth PMOS transistor 523. The fifth PMOS transistor 521 is connected to the external power supply voltage VDD. The gate of the fifth PMOS transistor 521 receives an inverted version of the control signal CON. The sixth PMOS transistor 523 is connected between the fifth PMOS transistor 521 and the fifth node N5. The gate of the sixth PMOS transistor 523 receives the comparison voltage Vc. The inverter 530 inverts the control signal CON to output the inverted version of the control signal CON, which is also referred to herein as an inverted control signal.

The fourth PMOS transistor 513 is selectively turned on based on whether the third PMOS transistor 511 is turned on in response to the control signal CON, and the first internal voltage VINT1 is provided at the fourth node N4. The sixth PMOS transistor 523 is selectively turned on based on whether the fifth PMOS transistor 521 is turned on in response to the inverted version of the control signal CON, and the second internal voltage VINT2 is provided at the fifth node N5.

The selection unit 600 may include a multiplexer (MUX) 610. The multiplexer 610 selects one of the first and second internal voltages VINT1 and VINT2 as the selected internal voltage SVINT to be provided to the comparison unit 400, in response to the control signal CON.

The bias unit 700a may include a comparator 710a and a third NMOS transistor 720a. The comparator 710a includes a first (positive) input terminal connected to the reference voltage VREF and a second (negative) input terminal connected to the selected internal voltage SVINT. The comparator 710a compares the levels of the reference voltage VREF and the selected internal voltage SVINT and outputs a bias voltage VB according to the result of the comparison. The drain of the third NMOS transistor 720a is connected to the third node N3. The source of the third NMOS transistor 720a is connected to ground. The gate of the third NMOS transistor 720a receives the bias voltage VB. In some exemplary embodiments, the amount of the bias current IB flowing from the third node N3 through the third NMOS transistor 720a to ground may be varied according to the level of the bias voltage VB applied to the gate of the third NMOS transistor 720a.

For example, it is assumed for illustration and description that the first driving unit 510 is enabled in response to the control signal CON in a first logic level, i.e., a low logic level. Also, the level of the reference voltage VREF may be substantially fixed.

The third PMOS transistor 511 is turned on and the fifth PMOS transistor 521 is turned off in response to the control signal CON being at the first logic level, and the selection unit 610 selects the first internal voltage VINT1 as the selected internal voltage SVINT, in response to the control signal CON. When the level of the selected internal voltage SVINT is lower than the reference voltage VREF, more current is flowing through the first NMOS transistor 421 than the second NMOS transistor 423. Accordingly, when the level of the selected internal voltage SVINT is lowered, the level of the bias voltage VB rises, and the bias current IB flowing from the third node N3 through the third NMOS transistor 720a to ground increases. When the level of the selected internal voltage SVINT is higher than the reference voltage VREF, less current is flowing through the first NMOS transistor 421 than the second NMOS transistor 423. Accordingly, when the level of the selected internal voltage SVINT rises, the level of the bias voltage VB is lowered and the bias current IB flowing from the third node N3 through the third NMOS transistor 720a to the ground decreases. Therefore, in some exemplary embodiments, the bias current IB for driving the comparison unit 400 may be adaptively adjusted in consideration of the level of the selected internal voltage SVINT (the first internal voltage VINT1) applied to the internal circuit.

As another illustrative example, it is assumed for illustration and description that the second driving unit 520 is enabled in response to the control signal CON in the second logic level, i.e., the high logic level.

The third PMOS transistor 511 is turned off and the fifth PMOS transistor 521 is turned on in response to the control signal CON being at the second logic level, and the selection unit 610 selects the second internal voltage VINT2 as the selected internal voltage SVINT, in response to the control signal CON. When the level of the selected internal voltage SVINT is lower than the reference voltage VREF, more current is flowing through the first NMOS transistor 421 than the second NMOS transistor 423. Accordingly, when the level of the selected internal voltage SVINT is lowered, the level of the bias voltage VB rises, and the bias current IB flowing from the third node N3 through the third NMOS transistor 720a to ground increases. When the level of the selected internal voltage SVINT is higher than the reference voltage VREF, less current is flowing through the first NMOS transistor 421 than the second NMOS transistor 423. Accordingly, when the level of the selected internal voltage SVINT rises, the level of the bias voltage VB is lowered, and the bias current IB flowing from the third node N3 through the third NMOS transistor 720a to ground decreases. Therefore, in some exemplary embodiments, the bias current IB for driving the comparison unit 400 may be adaptively adjusted in consideration of the level of the selected internal voltage SVINT (the second internal voltage VINT2) applied to the internal circuit.

FIG. 6B is a schematic circuit diagram illustrating another example of the internal voltage generator of FIG. 5 according to some exemplary embodiments. The internal voltage generator 20b of FIG. 6A is different from the internal voltage generator 20a of FIG. 6A in that the internal voltage generator 20b includes a bias unit 700b instead of the bias unit 700a. Therefore, the bias unit 700b will be described in detail with reference to FIG. 6B. It is noted that detailed description of elements, features or aspects of the embodiments of FIG. 6B that are the same as those of the embodiments of FIG. 6A will not be repeated.

Referring to FIG. 6B, the bias unit 700b may include a comparator 710b and a third NMOS transistor 720b. The comparator 710b includes a first (positive) input terminal connected to the first node N1 and, therefore, receives a signal VN1, and a second (negative) input terminal connected to the second node N2 and, therefore, receives a signal VN2. The comparator 710b compares the voltage levels of the first and second nodes N1 and N2 and outputs a bias voltage VB according to the result of the comparison. The drain of the third NMOS transistor 720b is connected to the third node N3. The source of the third NMOS transistor 720b is connected to ground. The gate of the third NMOS transistor 720b receives the bias voltage VB. The amount of the bias voltage VB flowing from the third node N3 through the third NMOS transistor 720b to ground may be varied according to the level of the bias voltage VB applied to the gate of the third NMOS transistor 720b.

When the level of the selected internal voltage SVINT is lower than the reference voltage VREF, more current is flowing through the first NMOS transistor 421 than the second NMOS transistor 423. Therefore, the voltage level of the first node N1 is lower than the voltage level of the second node N2, and thus the level of the bias voltage VB rises. When the level of the bias voltage VB rises, the bias current IB flowing from the third node N3 through the third NMOS transistor 720a to ground increases. When the level of the selected internal voltage SVINT is higher than the reference voltage VREF, less current is flowing through the first NMOS transistor 421 than the second NMOS transistor 423. Therefore, the voltage level of the first node N1 is higher than the voltage level of the second node N2, and thus the level of the bias voltage VB is lowered. When the level of the bias voltage VB is lowered, the bias current IB flowing from the third node N3 through the third NMOS transistor 720a to ground decreases. Therefore, the bias current IB for driving the comparison unit 400 may be adaptively adjusted in consideration of the level of the selected internal voltage SVINT (the first internal voltage VINT1) applied to the internal circuit.

Therefore, according to the inventive concept, the exemplary embodiments of the internal voltage generators 20a and 20b illustrated in and described in detail with reference to FIGS. 6A and 6B may selectively provide internal voltage to various internal circuits by including one comparison unit, and thus, the internal voltage generators 20a and 20b of FIGS. 6A and 6B may provide power effectively without increasing the number of circuit elements and chip size, as contrasted with a configuration in which separate multiple internal voltage generators are used.

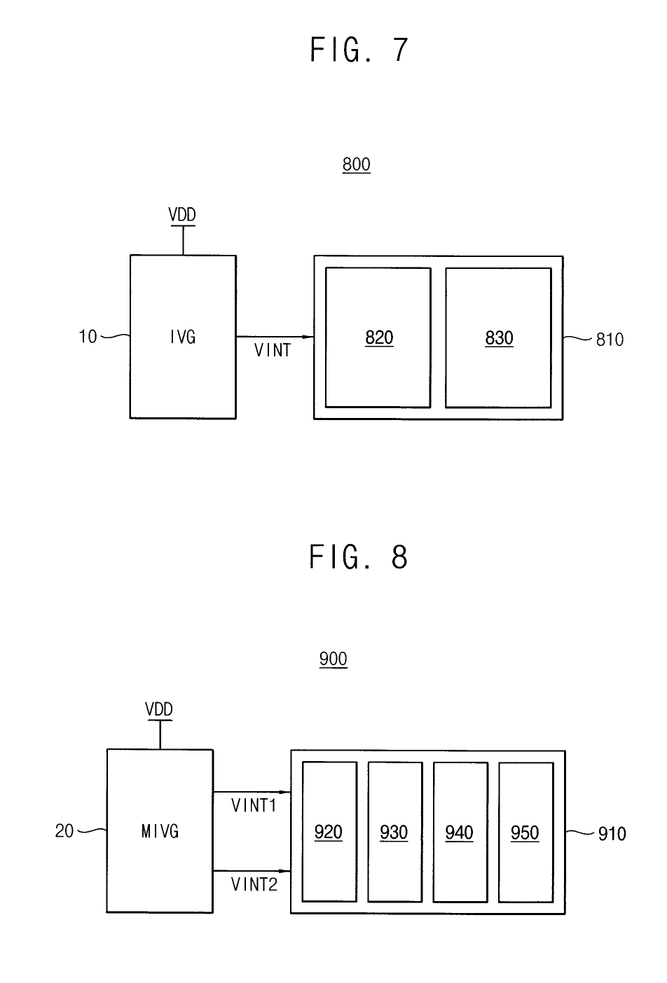

FIG. 7 is a schematic block diagram illustrating an example of an integrated circuit device according to some exemplary embodiments. The integrated circuit device of FIG. 7 may be a semiconductor memory device. Referring to FIG. 7, the semiconductor memory device 800 may include, for example, the internal voltage generator 10 of FIG. 1 and an internal circuit 810.

The internal voltage generator 10 is provided with the external power supply voltage VDD to generate the internal voltage VINT as illustrated in and described in detail above with reference to FIGS. 1 and 4. The internal circuit 810 is provided with the internal voltage VINT and uses the internal voltage VINT as an operating voltage. The internal circuit 810 may include, for example, a peripheral circuit 820 and a core circuit 830. The core circuit 830 may include a memory cell array, a row decoder, a column decoder, and a sense amplifier, and the peripheral circuit 820 may include a row address buffer, a column address buffer, a refresh controller and a voltage generator.

FIG. 8 is a schematic block diagram illustrating another example of an example of an integrated circuit device according to some exemplary embodiments. The integrated circuit device of FIG. 8 may be a semiconductor memory device. Referring to FIG. 8, the semiconductor memory device 900 may include, for example, the internal voltage generator 20 of FIG. 5 and an internal circuit 910. The internal circuit 910 may include an input circuit 920, a peripheral circuit 930, a memory cell array 940, and an output circuit 950. The internal voltage generator 20 may selectively provide one or more of the input circuit 920, the peripheral circuit 930, the memory cell array 940, and the output circuit 950 with an internal voltage which the one or more of the input circuit 920, the peripheral circuit 930, the memory cell array 940, and the output circuit 950 use as its/their operating voltage. In some embodiments, the peripheral circuit 930 and the memory cell array 940 may be grouped into a first internal circuit. In addition, input circuit 920 and the output circuit 950 may be grouped into a second internal circuit. When the input circuit 920, the peripheral circuit 930, the memory cell array 940, and the output circuit 950 are grouped into first and second internal circuits, the internal voltage generator 20 may selectively provide the first and second internal voltages VINT1 and VINT2 to the first and second internal circuits. In some exemplary embodiments, the first and second internal circuits may have separate power supply lines for preventing incoming noise.

In some exemplary embodiments, when the semiconductor memory device 900 performs a data read operation, the second internal circuit including the output circuit 950 for driving the output driver may need relatively more power than a case in which the semiconductor memory device 900 performs a data write operation. In this case, the first internal voltage VINT1 may be provided to the first internal circuit including the memory cell array 940 by setting the control signal CON to a first internal voltage activation mode, or the second internal voltage VINT2 may be provided to the second internal circuit including the input circuit 920 and the output circuit 950 by setting the control signal CON to a second internal voltage activation mode.

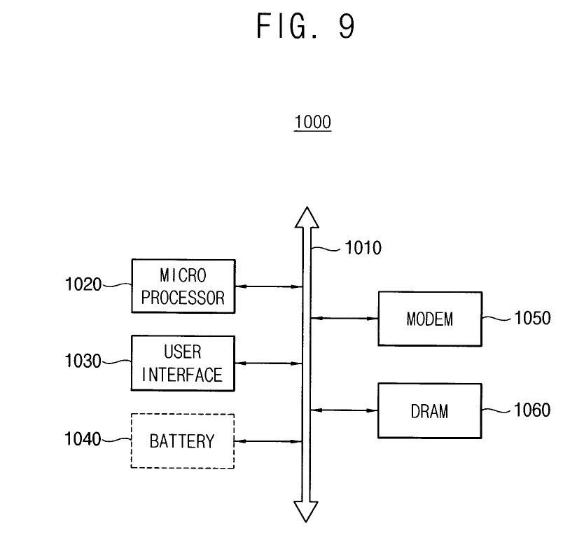

FIG. 9 contains a schematic block diagram which illustrates a system including the semiconductor memory devices according to some exemplary embodiments. Referring to FIG. 9, the application system 1000 includes a microprocessor 1020 connected to a bus 1010, a user interface 1030, a modem 1050 such as baseband chipset, and a memory device 1060, such as a DRAM memory device. The memory device 1060 may be one of the semiconductor memory devices 800 of FIG. 7 and/or the semiconductor memory device 900 of FIG. 8. The memory device 1060 stores data processed or to be processed by the microprocessor 1020. When the application system 1000 is a mobile electronic device, a battery 1040 may be provided to supply operational power. The application system 1000 may further include other elements such as an application chipset, a camera image processor (CIS), a mobile DRAM, a NAND flash memory, and/or other such device. In accordance with the exemplary embodiments of the inventive concept described herein in detail, the memory device 1060 may adaptively adjust the bias current according to the amount of load current to reduce the current consumption. Therefore, when the application system is a mobile application, the memory device 1060 may be a mobile DRAM.

The internal voltage generator and the semiconductor memory device according to exemplary embodiments may be widely applicable to a mobile memory device such that a stable internal voltage is provided and current consumption is reduced. The foregoing is illustrative of exemplary embodiments and is not to be construed as limiting thereof. Although some exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims.

What is claimed is:

1. An internal voltage generator for a semiconductor memory device, the internal voltage generator comprising:
a comparison unit for comparing a reference voltage and an internal voltage, the comparison unit being configured to output a comparison voltage based on a difference between the reference voltage and the internal voltage;
a driving circuit which receives the comparison voltage and an external power supply voltage, the driving circuit being configured to output the internal voltage to an output node in response to the comparison voltage; and
a bias unit which receives the internal voltage and through which a bias current flows, the bias unit being configured to adaptively adjust the bias current to drive the comparison unit, in consideration of a level of the internal voltage.

2. The internal voltage generator of claim 1, wherein the comparison unit comprises:
a first p-type metal-oxide semiconductor (PMOS) transistor connected between the external power supply voltage and a first node, the comparison voltage being provided at the first node;
a second PMOS transistor connected between the external power supply voltage and a second node, the first and second PMOS transistors forming a current mirror circuit;
a first n-type metal-oxide semiconductor (NMOS) transistor connected between the first node and a third node, the third node being connected to the driving circuit, a gate of the first NMOS transistor receiving the reference voltage; and
a second NMOS transistor connected between the second node and the third node, a gate of the second NMOS transistor receiving the internal voltage.

3. The internal voltage generator of claim 2, wherein the driving circuit comprises a third PMOS transistor, a source of the third PMOS transistor being connected to the external power supply voltage, a drain of the third PMOS transistor being connected to the output node, and a gate of the third PMOS transistor receiving the comparison voltage.

4. The internal voltage generator of claim 2, wherein the bias unit comprises:
a comparator which compares voltage levels of the first and second nodes to provide a comparison result, a bias voltage being provided according to the comparison result; and
a third NMOS transistor connected to the third node and a ground voltage, a gate of the third NMOS transistor receiving the bias voltage to adjust the bias current in response to the bias voltage.

5. The internal voltage generator of claim 2, wherein the bias unit comprises:
a comparator which compares levels of the reference voltage and the internal voltage to provide a comparison result, a bias voltage being provided according to the comparison result; and
a third NMOS transistor connected to the third node and a ground voltage, a gate of the third NMOS transistor receiving the bias voltage to adjust the bias current in response to the bias voltage.

6. An internal voltage generator for a semiconductor memory device, the internal voltage generator comprising:
a comparison unit for comparing one of a plurality of internal voltages and a reference voltage, the comparison unit being configured to output a comparison voltage based on a difference between the one of the plurality of internal voltages and the reference voltage;
a driving circuit which receives an external power supply voltage and the comparison voltage, the driving circuit being configured to selectively generate one of the internal voltages to be provided to an internal circuit in response to a control signal;
a selection unit which receives the internal voltages, the selection unit being configured to select one of the internal voltages in response to the control signal, the selected one of the internal voltages being provided to the internal circuit as a selected internal voltage; and
a bias unit which receives the selected internal voltage, the bias unit being configured to adaptively adjust a bias current to drive the comparison unit in consideration of a level of the selected internal voltage.

7. The internal voltage generator of claim 6, wherein the driving circuit comprises first and second driving units, the first and second driving units being selectively enabled in response to the control signal, the first and second driving units outputting one of the internal voltages based on the external power supply voltage and the comparison voltage.

8. The internal voltage generator of claim 7, wherein the first driving unit comprises:
a first p-type metal-oxide semiconductor (PMOS) transistor connected to the external power supply voltage, a gate of the first PMOS transistor receiving the control signal; and
a second PMOS transistor connected to the first PMOS transistor and the selection unit, a gate of the second PMOS transistor receiving the comparison voltage, wherein the second driving unit comprises;
a third PMOS transistor connected to the external power supply voltage, a gate of the third PMOS transistor receiving an inverted version of the control signal; and
a fourth PMOS transistor connected to the third PMOS transistor and the selection unit, a gate of the fourth PMOS transistor receiving the comparison voltage, and
wherein a first internal voltage is provided at a drain of the second PMOS transistor, and a second internal voltage is provided at a drain of the fourth PMOS transistor.

9. The internal voltage generator of claim 8, wherein the first internal voltage is selectively provided based on whether the first PMOS transistor is turned on in response to the control signal, and wherein the second internal voltage is selectively provided based on whether the third PMOS transistor is turned on in response to the inverted version of the control signal.

10. The internal voltage generator of claim 8, wherein the comparison unit comprises:
a fifth PMOS transistor connected between the external power supply voltage and a first node, the comparison voltage being provided at the first node;
a sixth PMOS transistor connected between the external power supply voltage and a second node, the first and second PMOS transistors forming a current mirror circuit;
a first n-type metal-oxide semiconductor (NMOS) transistor connected between the first node and a third node, the third node being connected to the driving circuit, a gate of the first NMOS transistor receiving the reference voltage; and
a second NMOS transistor connected between the second node and the third node, a gate of the second NMOS transistor receiving the internal voltage.

11. The internal voltage generator of claim 10, wherein the bias unit comprises:
a comparator which compares levels of the reference voltage and the selected internal voltage to provide a comparison result, a bias voltage being provided according to the comparison result; and
a third NMOS transistor connected to the third node and a ground voltage, a gate of the third NMOS transistor receiving the bias voltage to adjust the bias current in response to the bias voltage.

12. The internal voltage generator of claim 8, wherein the selection unit comprises a multiplexer which selects one of the first and second internal voltages to output the selected internal voltage.

13. The internal voltage generator of claim 8, wherein the selection unit selects the first internal voltage of the first and second internal voltages when the control signal is a first logic level, and the selection unit selects the second internal voltage of the first and second internal voltages when the control signal is a second logic level.

14. An integrated circuit device, comprising:
an internal voltage generator circuit for generating an internal voltage, the internal voltage generator circuit comprising:
a comparison unit for comparing a reference voltage and the internal voltage, the comparison unit being configured to output a comparison voltage based on a difference between the reference voltage and the internal voltage,
a driving circuit which receives the comparison voltage and an external power supply voltage, the driving circuit being configured to output the internal voltage to an output node in response to the comparison voltage, and
a bias unit which receives the internal voltage and through which a bias current flows, the bias unit being configured to adaptively adjust the bias current to drive the comparison unit, in consideration of a level of the internal voltage; and
an internal circuit receiving the internal voltage and using the internal voltage as an operating voltage.

15. The integrated circuit device of claim 14, wherein the integrated circuit device comprises a semiconductor memory device.

16. The integrated circuit device of claim 15, wherein the semiconductor memory device comprises a DRAM device.

17. The integrated circuit device of claim 14, wherein the internal circuit comprises a memory cell array.

18. The integrated circuit device of claim 17, wherein the memory cell array is a DRAM memory cell array.

19. The integrated circuit device of claim 14, wherein the internal circuit comprises a peripheral circuit associated with a memory cell array.

20. The integrated circuit device of claim 14, wherein the internal circuit comprises a memory circuit and a peripheral circuit associated with the memory cell array.
